(19) United States
(12) Patent Application Publication
(10) Pub. No.: US 2026/0331661 A1
(43) Pub. Date: Oct. 22, 2026

(54) LITHIUM ION BATTERY AND MANUFACTURING METHOD OF LITHIUM ION BATTERY

(71) Applicant: NIPPON STEEL CORPORATION, Tokyo (JP)

(72) Inventors: Misaki ASADA, Tokyo (JP); Takehiro TAKAHASHI, Tokyo (JP)

(73) Assignee: NIPPON STEEL CORPORATION, Tokyo (JP)

(21) Appl. No.: 19/099,518

(22) PCT Filed: Sep. 14, 2023
(86) PCT No.: PCT/JP2023/033546

§ 371 Date: Jan. 29, 2025

(30) Foreign Application Priority Data
Sep. 15, 2022 (JP) 2022-146919

(51) Int. Cl. H01M 50/186; H01M 10/0525; H01M 50/103; H01M 50/119; H01M 50/15; H01M 50/636

(52) U.S. Cl. CPC H01M 50/186; H01M 10/0525; H01M 50/103; H01M 50/119; H01M 50/15; H01M 50/636

(57) ABSTRACT

A lithium ion battery including an accommodation case accommodating a battery unit having a positive electrode, a negative electrode, and a separator, and an electrolytic solution containing a lithium salt. A Ni-plated steel sheet or a laminated steel sheet is used as a material of the case. The battery includes, on the case, a first sealing portion being a sealing portion between a main body part and a lid part, and a second sealing portion being a sealing portion between a liquid pouring port lid for sealing a liquid pouring port provided to the lid part and used for pouring the electrolytic solution into the accommodation case, and the lid part exists. A coating film part contains a Ca compound, an Al compound, and a La compound exists on a portion with a content of Fe of 80 mass % or more, of the first sealing portion or the second sealing portion.

### TECHNICAL FIELD

The present invention relates to a lithium ion battery and a manufacturing method of a lithium ion battery.

### BACKGROUND ART

In recent years, an application of secondary batteries such as a lithium ion battery is rapidly expanding in a power storage device for power storage combined with a new energy system such as a solar cell and wind power generation, a storage battery for automobile, and so on. For this reason, a lithium ion battery mounted on the power storage device for power storage, the storage battery for automobile, and so on, is required of higher safety. Accordingly, in order to further improve the safety of the lithium ion battery, various techniques have been proposed in recent years.

For example, Patent Document 1 below proposes a technique in which at least a part of a surface of an exterior member that accommodates an electrode body is covered with an insulating member. In such a technique, a side of the above-described insulating member in contact with the exterior member is set to a nonflammable gas generating member that generates nonflammable gas at high temperature, and an outermost layer is set to an insulating resin layer, to thereby realize both an insulation function of the battery and an ignition prevention function of the battery.

### PRIOR ART DOCUMENT

### Patent Document

Patent Document 1: International Publication Pamphlet No. WO 2021-014996

### DISCLOSURE OF THE INVENTION

### Problems to be Solved by the Invention

The present inventors came up with an idea that in the lithium ion battery as described above, a Ni-plated steel sheet obtained by providing a Ni-plating layer on a base steel sheet, or a laminated steel sheet obtained by providing a surface-treated layer on a base steel sheet is used as a material of an accommodation case that accommodates a battery unit having a positive electrode, a negative electrode, and a separator, and an electrolytic solution containing a lithium salt.

When the Ni-plated steel sheet or the laminated steel sheet as described above is used as a material of a main body part and a lid part of the accommodation case, the main body part and the lid part of the accommodation case after accommodating the battery unit and the electrolytic solution, are sealed by welding processing typified by laser welding and the like, or caulking. Further, depending on cases, it can be supposed to provide, to the lid part of the accommodation case, a liquid pouring port for pouring the electrolytic solution into the accommodation case. In such a case, the electrolytic solution is poured into the main body part in which the battery unit is accommodated, via the liquid pouring port provided to the lid part, and then the liquid pouring port provided to the lid part is sealed by using a liquid pouring port lid, through welding processing or caulking.

Here, it can be considered a case where, when the electrolytic solution as described above is poured, a part of the electrolytic solution is adhered to an outer surface of the main body part and the lid part of the accommodation case. The electrolytic solution used for the lithium ion battery contains, as its component, a lithium salt (for example, a lithium salt containing fluorine such as LiPF₆). When such a lithium salt and moisture in the atmosphere react with each other, hydrofluoric acid (HF) is generated. On the other hand, there is a possibility that, due to the welding processing or the caulking used for sealing, a part of the Ni-plating layer of the Ni-plated steel sheet or the surface-treated layer of the laminated steel sheet is eliminated, resulting in that the base steel sheet is exposed. Further, depending on the structure of the accommodation case, there can be considered a case where an end portion of the base steel sheet on which the Ni-plating layer or the surface-treated layer is not provided, is exposed to the surface.

The present inventors newly found out a problem that, when hydrofluoric acid (HF) is generated at the exposed portion of the base steel sheet as above, the generated hydrofluoric acid corrodes the base steel sheet to generate red rust, which deteriorates an outer surface corrosion resistance of the accommodation case. Such a problem is a problem that is generated only after the Ni-plated steel sheet or the laminated steel sheet is used as the material of the main body part and the lid part of the accommodation case.

The problem as described above regarding the outer surface corrosion resistance of the accommodation case found out for the first time by the present inventors, cannot be solved even if ingenuity is exercised as much as possible on a portion that is not brought into contact with atmosphere, as in the nonflammable gas generating member disclosed in Patent Document 1 described above, for example. For this reason, it is required to newly realize a technique capable of keeping the outer surface corrosion resistance of the lithium ion battery even in a case where the electrolytic solution has been adhered to the outer surface of the lithium ion battery.

Accordingly, the present invention has been made in view of the above-described problems, and an object of the present invention is to provide a lithium ion battery and a manufacturing method of a lithium ion battery capable of keeping an outer surface corrosion resistance of the lithium ion battery even in a case where an electrolytic solution has been adhered to an outer surface of the lithium ion battery.

### Means for Solving the Problems

As a result of earnest studies conducted by the present inventors in order to solve the above-described problems, they found out that it is important to deal with the generated hydrofluoric acid, based on that it can be considered that it is difficult to completely prevent the adhesion of the electrolytic solution, and the contact between the lithium ion battery and the moisture in the atmosphere is unavoidable when considering the time of using the battery. The present inventors then conceived an idea that, if it is possible to previously provide a unit of invalidating the hydrofluoric acid that is generated through the reaction with the moisture in the atmosphere, to the outer surface of the lithium ion battery, it is possible to keep the outer surface corrosion resistance of the lithium ion battery.

The gist of the present invention completed based on the findings as described above, is as follows.
(1) A lithium ion battery including an accommodation case having a main body part and a lid part, the accommodation case accommodating, in the inside thereof, a battery unit having a positive electrode, a negative electrode, and a separator, and an electrolytic solution containing a lithium salt, in which a Ni-plated steel sheet having a Ni-plating layer on a base steel sheet, or a laminated steel sheet having a surface-treated layer on a base steel sheet is used as a material of the accommodation case, on the accommodation case, at least any of a first sealing portion being a sealing portion between the main body part and the lid part, and a second sealing portion being a sealing portion between a liquid pouring port lid for sealing a liquid pouring port provided to the lid part and used for pouring the electrolytic solution into the accommodation case, and the lid part exists, and a coating film part containing at least any of a Ca compound, an Al compound, and a La compound exists on a portion with a content of Fe of 80 mass % or more, of the first sealing portion or the second sealing portion.
(2) In the lithium ion battery described in (1), a total adhesion amount of the Ca compound in terms of metal Ca, the Al compound in terms of metal Al, and the La compound in terms of metal La, in the coating film part is 0.001 g/m² or more and 1000.000 g/m² or less.
(3) In the lithium ion battery described in (1), the Ca compound, the Al compound, and the La compound are dispersed in a resin in the coating film part.
(4) In the lithium ion battery described in (2), the Ca compound, the Al compound, and the La compound are dispersed in a resin in the coating film part.
(5) In the lithium ion battery described in any one of (1) to (4), the Ca compound is at least any of a calcium carbonate, a calcium oxide, and a calcium hydroxide, the Al compound is at least any of an aluminum carbonate, an aluminum oxide, and an aluminum hydroxide, and the La compound is a lanthanum carbonate, a lanthanum oxide, or a lanthanum hydroxide.
(6) In the lithium ion battery described in (5), 80 mass % or more of the Ca compound in terms of metal Ca is the calcium hydroxide.
(7) In the lithium ion battery described in (5), the coating film part further contains a fluoride as the Ca compound, the Al compound, or the La compound.
(8) In the lithium ion battery described in (6), the coating film part further contains a fluoride as the Ca compound, the Al compound, or the La compound.
(9) In the lithium ion battery described in (7), the fluoride exists more on a side of interface with the base steel sheet constituting the Ni-plated steel sheet or the laminated steel sheet than on a side of surface of the coating film part.
(10) In the lithium ion battery described in (8), the fluoride exists more on a side of interface with the base steel sheet constituting the Ni-plated steel sheet or the laminated steel sheet than on a side of surface of the coating film part.
(11) In the lithium ion battery described in (7), an adhesion amount of the fluoride in terms of fluorine is greater than 0 g/m² and 0.200 g/m² or less.
(12) In the lithium ion battery described in (8), an adhesion amount of the fluoride in terms of fluorine is greater than 0 g/m² and 0.200 g/m² or less.
(13) In the lithium ion battery described in (9), an adhesion amount of the fluoride in terms of fluorine is greater than 0 g/m² and 0.200 g/m² or less.
(14) In the lithium ion battery described in (10), an adhesion amount of the fluoride in terms of fluorine is greater than 0 g/m² and 0.200 g/m² or less.
(15) In the lithium ion battery described in (1), the first sealing portion and the second sealing portion are formed through welding or caulking.
(16) A manufacturing method of a lithium ion battery that includes an accommodation case having a main body part and a lid part, the accommodation case accommodating, in the inside thereof, a battery unit having a positive electrode, a negative electrode, and a separator, and an electrolytic solution containing a lithium salt, in which on the lithium ion battery, at least any of a first sealing portion being a sealing portion between the main body part and the lid part, and a second sealing portion being a sealing portion between a liquid pouring port lid for sealing a liquid pouring port provided to the lid part and used for pouring the electrolytic solution into the accommodation case, and the lid part is formed, and a Ni-plated steel sheet having a Ni-plating layer on a base steel sheet, or a laminated steel sheet having a surface-treated layer on a base steel sheet is used as a material of the accommodation case, the manufacturing method of the lithium ion battery including: a sealing step of sealing between the main body part and the lid part, and between the liquid pouring port lid and the lid part to form the first sealing portion and the second sealing portion, regarding the accommodation case that accommodates the battery unit and the electrolytic solution; and a coating step of coating a top of a portion with a content of Fe of 80 mass % or more, of the first sealing portion or the second sealing portion, with paint containing at least any of a Ca compound, an Al compound, and a La compound, after performing the sealing between the main body part and the lid part, and between the liquid pouring port lid and the lid part.
(17) In the manufacturing method of the lithium ion battery described in (16), the sealing step is performed under an atmosphere of a dew point of −75° C. or less.

### Effect of the Invention

As described above, according to the present invention, it becomes possible to keep an outer surface corrosion resistance of a lithium ion battery even in a case where an electrolytic solution has been adhered to an outer surface of the lithium ion battery.

### BRIEF DESCRIPTION OF THE DRAWINGS

FIG. 1A is an explanatory view schematically illustrating a lithium ion battery according to each embodiment of the present invention.

FIG. 1B is an explanatory view schematically illustrating a lithium ion battery according to each embodiment of the present invention.

FIG. 2A is an explanatory view schematically illustrating a lithium ion battery according to each embodiment of the present invention.

FIG. 2B is an explanatory view schematically illustrating a lithium ion battery according to each embodiment of the present invention.

FIG. 3 is an explanatory view schematically illustrating a material of an accommodation case of a lithium ion battery according to a first embodiment of the present invention.

FIG. 4A is an explanatory view schematically illustrating the lithium ion battery according to the same embodiment.

FIG. 4B is an explanatory view schematically illustrating the lithium ion battery according to the same embodiment.

FIG. 5A is an explanatory view schematically illustrating the lithium ion battery according to the same embodiment.

FIG. 5B is an explanatory view schematically illustrating the lithium ion battery according to the same embodiment.

FIG. 6 is an explanatory view schematically illustrating a material of an accommodation case of a lithium ion battery according to a second embodiment of the present invention.

FIG. 7 is an explanatory view schematically illustrating a material of an accommodation case of a lithium ion battery according to a third embodiment of the present invention.

FIG. 8A is a flow chart illustrating one example of a flow of a manufacturing method of a lithium ion battery according to each embodiment of the present invention.

FIG. 8B is a flow chart illustrating one example of a flow of a manufacturing method of a lithium ion battery according to each embodiment of the present invention.

### EMBODIMENTS FOR CARRYING OUT THE INVENTION

Hereinafter, preferred embodiments of the present invention will be explained in detail while referring to the attached drawings. Note that in this description and drawings, components having substantially the same functional configuration will be denoted by the same codes, to thereby omit overlapped explanation.

### (Regarding Lithium Ion Battery)

### <Regarding Overall Configuration of Lithium Ion Battery>

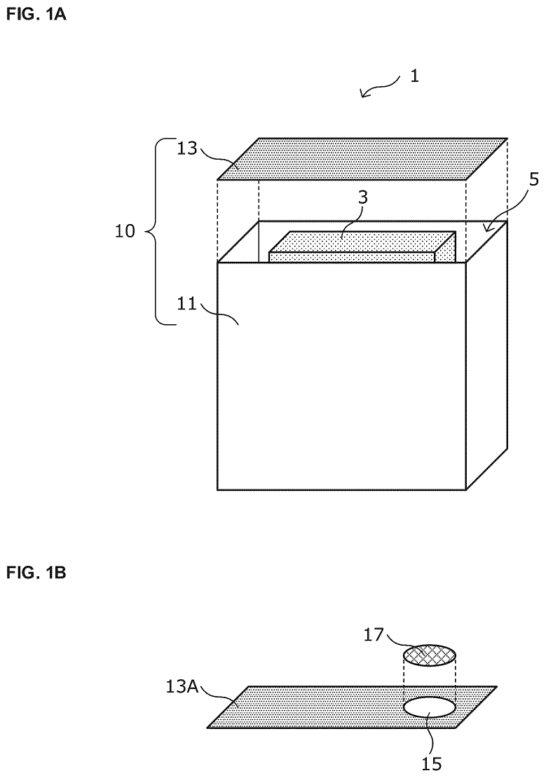

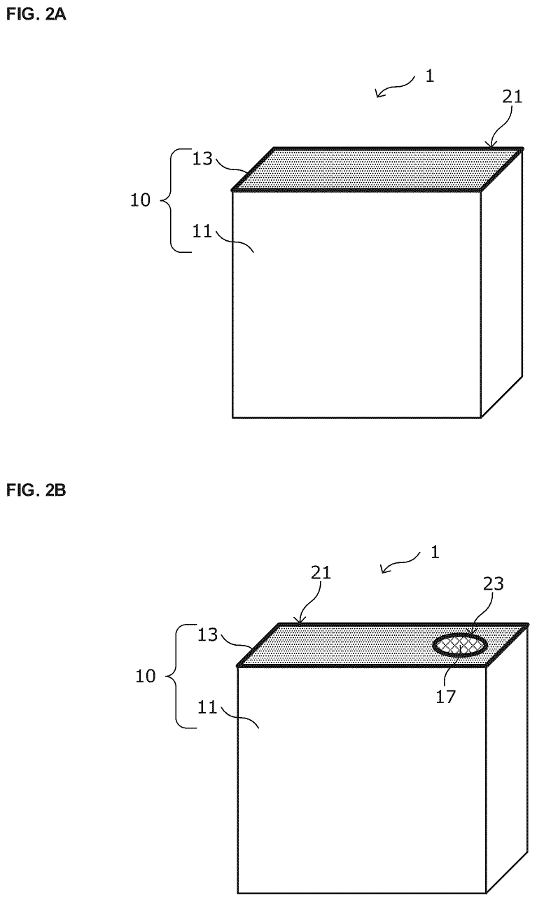

First, an overall configuration of a lithium ion battery according to each embodiment of the present invention will be explained while referring to FIG. 1A to FIG. 2B. Each of FIG. 1A to FIG. 2B is an explanatory view schematically illustrating a lithium ion battery according to each embodiment of the present invention.

As schematically illustrated in FIG. 1A, a lithium ion battery 1 according to each embodiment of the present invention is obtained by accommodating a battery unit 3 having a positive electrode, a negative electrode, and a separator, and an electrolytic solution 5 containing a lithium salt, in the inside of an accommodation case 10 having a main body part 11 and a lid part 13.

### [Regarding Battery Unit 3 and Electrolytic Solution 5]

Here, the positive electrode (not illustrated), the negative electrode (not illustrated), and the separator (not illustrated) constituting the battery unit 3, and various kinds of active materials (not illustrated) provided to the positive electrode and the negative electrode, are not limited in particular. As these respective members constituting the battery unit 3, various members used for a lithium ion battery can be appropriately used. Further, a concrete structure of the battery unit 3 is not limited in particular as well, and various structures can be adopted.

Further, concrete shape and size of the battery unit 3 are not limited in particular as well. Although FIG. 1A illustrates the battery unit 3 having a square shape, for the sake of convenience, the shape of the battery unit 3 may be a columnar shape, or another shape.

Further, the electrolytic solution 5 is only required to contain a lithium salt capable of generating lithium ions, and it is possible to appropriately use an electrolytic solution containing various kinds of lithium salt (a lithium salt containing fluorine, in particular). As such a lithium salt, there can be cited, for example, LiPF₆, LiBF₄, and LiN(SO₂CF₃)₂ (also referred to as LiFSI).

### [Regarding Accommodation Case 10]

As illustrated in FIG. 1A, the accommodation case 10 in the lithium ion battery 1 according to the present embodiment accommodates, in the inside thereof, the battery unit 3 and the electrolytic solution 5 as described above, and is formed of the main body part 11 and the lid part 13.

The main body part 11 of the accommodation case 10 is a hollow member having an inner space capable of accommodating the battery unit 3 and the electrolytic solution 5. The main body part 11 is formed of a portion to be a bottom surface (not illustrated), and portions to be side surfaces. In FIG. 1A, the main body part 11 realizes the inner space that accommodates the battery unit 3 and the electrolytic solution 5, with a rectangular bottom surface (not illustrated) and four side surfaces. After the battery unit 3 and the electrolytic solution 5 are accommodated in the inner space of the main body part 11, an opening portion of the main body part 11 is closed by the lid part 13, as illustrated in FIG. 1A.

Here, FIG. 1A illustrates a case where the main body part 11 of the accommodation case 10 has a square shape. However, a concrete shape of the main body part 11 is not defined in particular. The main body part 11 can have an arbitrary shape as long the shape is one capable of accommodating the battery unit 3 and the electrolytic solution 5.

Further, as illustrated in FIG. 1B, for example, there can be considered a case where a liquid pouring port 15 being an opening portion for pouring the electrolytic solution into the accommodation case, is provided to a part of the lid part 13A, and after pouring the electrolytic solution, the liquid pouring port 15 is closed by a liquid pouring port lid 17. In the accommodation case 10 according to the present embodiment, it is also possible to use a lid part 13A as illustrated in FIG. 1B, in place of the lid part 13 illustrated in FIG. 1A.

In the accommodation case 10 as illustrated in FIG. 1A, after the battery unit 3 and the electrolytic solution 5 are accommodated in the inner space of the main body part 11, the opening portion of the main body part 11 is closed by the lid part 13, and sealing processing is performed. Accordingly, the main body part 11 and the lid part 13 of the accommodation case 10 are integrated. Consequently, as schematically illustrated in FIG. 2A, on the accommodation case 10 after the sealing, there is generated a sealing portion between the main body part 11 and the lid part 13. Hereinafter, such “a sealing portion between the main body part and the lid part (a portion indicated by a heavy line in FIG. 2A)” will be referred to as a first sealing portion 21.

Further, in the accommodation case 10 as illustrated in FIG. 1B, after the battery unit 3 and the electrolytic solution 5 are accommodated in the inner space of the main body part 11, the opening portion of the main body part 11 is closed by the lid part 13A, and sealing processing is performed. Further, the liquid pouring port 15 provided to the lid part 13A is closed by the liquid pouring port lid 17, and sealing processing is performed. Accordingly, the main body part 11 and the lid part 13A of the accommodation case 10 are integrated. Consequently, the first sealing portion 21 is generated as the sealing portion between the main body part 11 and the lid part 13A, and there is also generated a sealing portion between the lid part 13A and the liquid pouring port lid 17. Hereinafter, such “a sealing portion between the liquid pouring port lid and the lid part (a portion indicated by a heavy line in FIG. 2B)” will be referred to as a second sealing portion 23.

Here, in each of the accommodation case 10 as illustrated in FIG. 1A, and the accommodation case 10 as illustrated in FIG. 1B, when pouring the electrolytic solution 5 into the main body part 11, a part of the electrolytic solution 5 may be adhered to outer surfaces (portions to be exposed to the atmosphere) of the main body part 11 and the lid parts 13, 13A.

Note that in order to specify, in an ex-post manner, the positions of the first sealing portion 21 and the second sealing portion 23 in the accommodation case 10 regarding the already-manufactured lithium ion battery, the following may be performed. Since the first sealing portion 21 is a portion at which the main body part 11 of the accommodation case 10 is sealed by the lid part 13, 13A, as described above, an attention may be focused on a joining portion between a body part and a lid part of a cell case in a focused lithium ion battery. Further, since the second sealing portion 23 is a portion at which the liquid pouring port 15 on the lid part 13A is sealed by the liquid pouring port lid 17, as described above, an attention may be focused on a joining portion between a liquid pouring port and a liquid pouring port lid in a focused lithium ion battery. More specifically, the entire focused lithium ion battery is embedded in a resin, the entire lithium ion battery is then cut in a longitudinal direction of the cell case at a position of a portion passing through a center of a short side of the lithium ion battery, or a position of a portion passing through a center of the liquid pouring port when the liquid pouring port exists, and a portion as described above in the obtained cross section may be observed through a SEM (Scanning Electron Microscope). At this time, a size of a visual field when performing the observation may be set to 1000 μm×1000 μm.

### First Embodiment

### <Regarding Material of Accommodation Case 10>

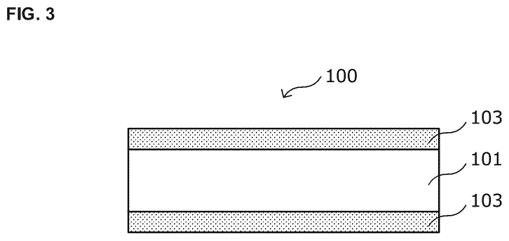

Next, the material of the accommodation case 10 according to the first embodiment of the present invention will be explained in detail while referring to FIG. 3. FIG. 3 is an explanatory view schematically illustrating the material of the accommodation case of the lithium ion battery according to the present embodiment.

As the material of the accommodation case 10 according to the present embodiment, a Ni-plated steel sheet or a laminated steel sheet is used. Hereinafter, a case of using the Ni-plated steel sheet as the material of the accommodation case 10 according to the present embodiment will be explained.

FIG. 3 schematically illustrates a layer structure of a Ni-plated steel sheet 100.

The Ni-plated steel sheet 100 used as the material of the accommodation case 10 has a base steel sheet 101, and Ni-plating layers 103 provided to front and rear surfaces of the base steel sheet 101, as illustrated in FIG. 3.

The base steel sheet 101 is a steel sheet to be a base of the Ni-plated steel sheet 100. Components, metal structures, and so on of such a base steel sheet 101 are not limited in particular. As the base steel sheet 101, it is possible to appropriately use various kinds of steel sheets such as, for example, low-carbon aluminum-killed steel and IF steel (Interstitial Free Steel: ultralow carbon steel).

Note that in order to specify, in an ex-post manner, the type of the base steel sheet 101, the measurement may be performed in accordance with JIS G 1258-1:2014, by using an ICP (Inductively Coupled Plasma) emission spectrochemical analysis method.

Further, a thickness of the base steel sheet 101 may also be appropriately set in accordance with mechanical strength required of the accommodation case 10, and it may be set to about 0.15 to 1.20 mm, for example.

The Ni-plating layer 103 positioned at a surface of the base steel sheet 101 is a plating layer containing at least Ni. The Ni-plating layer 103 may also be constituted of Ni and impurities, and at least a part of Ni constituting the Ni-plating layer 103 may also be alloyed with Fe derived from the base steel sheet 101. An average composition and so on of such a Ni-plating layer 103 are not limited in particular. As the Ni-plating layer 103, various kinds of Ni plating, Ni alloy plating, and the like can be adopted as long as they exhibit corrosion resistance with respect to the electrolytic solution 5 kept in the accommodation case 10.

As the average composition of such a Ni-plating layer 103, there can be cited a composition constituted of, for example, Ni: 95 to 50 mass %, Fe: 5 to 50 mass %, and impurities. Further, the Ni-plating layer 103 may also further contain an alloying element of any of Co, Sn, Zn, W, Mo, and Cr, in place of a part of Ni. As a forming method of such a Ni-plating layer 103, there can be cited, for example, various kinds of plating methods such as hot dipping using a plating bath and electroplating, thermal spraying, and vapor deposition.

Further, an adhesion amount per side of the Ni-plating layer 103 is preferably 5 to 50 g/m², for example. The adhesion amount per side of the Ni-plating layer 103 of 10 g/m² or more is more preferable since it becomes possible to further improve the corrosion resistance of the Ni-plated steel sheet 100. On the other hand, the adhesion amount per side of the Ni-plating layer 103 of 30 g/m² or less is more preferable since it becomes possible to further reduce a manufacturing cost of the Ni-plated steel sheet 100.

Note that the Ni-plated steel sheet 100 may also be one that is not subjected to heat treatment after plating, or it may also be one that is subjected to the heat treatment after the plating. When the heat treatment is performed after the plating, a diffusion alloy layer is formed at an interface between the base steel sheet 101 and the Ni-plating layer 103.

Note that the adhesion amount per side of the Ni-plating layer 103 can be measured through the ICP emission spectrochemical analysis method, for example. First, from arbitrary five locations of a bottom surface of an accommodation case of a focused lithium ion battery, samples each having a size of 30 mm×30 mm in plan view are respectively cut out, and respective Ni-plating layers 103 that exist in such samples are dissolved with acid (more specifically, 19% hydrochloric acid). Next, Total-Ni amounts contained in the respective dissolved solutions are subjected to a quantitative analysis by using an ICP emission spectrochemical analyzer (for example, ICPS-8100 manufactured by SHIMADZU CORPORATION). When the Total-Ni amount indicates a value greater than 0, this means that the Ni-plating layer 103 exists in the obtained sample. By dividing the obtained Total-Ni amount by the above-described sample area, it is possible to determine the Ni adhesion amount per unit area. An average value of the obtained five Ni adhesion amounts is dealt as the adhesion amount per side of the Ni-plating layer 103. Further, the average composition of the Ni-plating layer 103 can also be determined through the ICP emission spectrochemical analysis method, in a similar manner. Note that in a case where, at the time of cutting out the sample from the focused location, the size of any side of the sample becomes less than 30 mm, it is only required to cut out the sample from the focused location so that an area of the sample becomes 90 mm².

Further, in the Ni-plated steel sheet 100 as described above, various kinds of conversion treatment coating layer (not illustrated) may further exist between the base steel sheet 101 and the Ni-plating layer 103. When such a conversion treatment coating layer exists, it becomes possible to further improve the adhesiveness between the base steel sheet 101 and the Ni-plating layer 103. Further, when such a conversion treatment coating layer exists, it becomes possible to further improve the corrosion resistance of the Ni-plated steel sheet 100.

The conversion treatment coating layer as above is not limited in particular, and it may be formed by using various kinds of conversion treatment. As the conversion treatment as above, there can be cited, for example, chromate-based conversion treatment or non-chromate-based conversion treatment. As the non-chromate-based conversion treatment, there can be cited, for example, conversion treatment using inorganic compounds such as a vanadium compound, a titanium compound, a zirconium compound, and a phosphoric acid compound, and silica-based conversion treatment.

<Regarding Sealing Processing and Portion to be Coated with Coating Film Part>

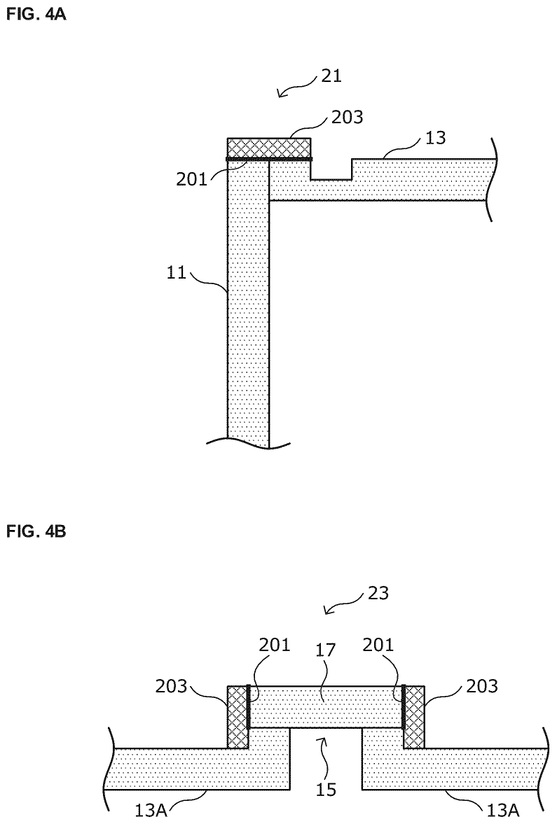

Hereinafter, sealing processing and a portion to be coated with a coating film part in the lithium ion battery 1 according to the present embodiment will be explained while referring to FIG. 4A and FIG. 4B. Each of FIG. 4A and FIG. 4B is an explanatory view schematically illustrating a lithium ion battery according to the present embodiment. FIG. 4A schematically illustrates a part of a cross section obtained by cutting the accommodation case 10 in a case height direction, and FIG. 4B schematically illustrates a part of a cross section obtained by cutting the vicinity of the liquid pouring port lid 17 of the accommodation case 10 in the case height direction.

When the material as illustrated in FIG. 3 is used to manufacture the main body part 11, the lid parts 13, 13A, and the liquid pouring port lid 17 of the accommodation case 10, in the various kinds of steel sheets used as the materials, an end face of the base steel sheet 101 that is not provided with the Ni-plating layer 103 is sometimes exposed to the surface. Further, the main body part 11 and the lid part 13, 13A, and the lid part 13A and the liquid pouring port lid 17 of the accommodation case 10 are sealed through the welding processing or the caulking. At this time, there is a possibility that a part of the Ni-plating layer 103 is eliminated by the sealing processing as above, and the base steel sheet 101 is exposed.

FIG. 4A schematically illustrates one example of a cross section in the vicinity of the first sealing portion 21. Note that a shape illustrated in FIG. 4A is only an example, and the shape in the vicinity of the first sealing portion 21 in the lithium ion battery 1 according to the present embodiment is not limited to such an example.

In the example illustrated in FIG. 4A, regarding a top surface of a portion being a side surface of the main body part 11 and an end portion of the lid part 13, an end face of the base steel sheet 101 to which the Ni-plating layer 103 is not provided is in a state of being exposed to the atmosphere.

FIG. 4B schematically illustrates one example of a cross section in the vicinity of the second sealing portion 23. Note that a shape illustrated in FIG. 4B is only an example, and the shape in the vicinity of the second sealing portion 23 in the lithium ion battery 1 according to the present embodiment is not limited to such an example.

In the example illustrated in FIG. 4B, at a side end of the liquid pouring port lid 17, an end face of the base steel sheet 101 is in a state of being exposed to the atmosphere.

The portion at which the end face of the base steel sheet 101 is exposed, and the portion at which a part of the Ni-plating layer 103 is eliminated through the sealing processing, as illustrated in FIG. 4A and FIG. 4B, are portions at which a part of the base steel sheet 101 is exposed and a content of Fe becomes 80 mass % or more. The portion at which the end face of the base steel sheet 101 is exposed, and the portion at which a part of the Ni-plating layer 103 is eliminated through the sealing processing as described above, when manufacturing the lithium ion battery, will be referred to as iron exposed portions, hereinbelow. In the present embodiment, such a portion at which a part of the base steel sheet 101 is exposed and a content of Fe becomes 80 mass % or more, will be set to a portion to be coated with a coating film part 30, as will be described below in detail.

Note that the reason why the iron exposed portion is set to a portion having a content of Fe of 80 mass % or more, is as follows. Specifically, when a part of the Ni-plating layer 103 is eliminated by the sealing processing, for example, an element other than Fe, derived from the Ni-plating layer 103, may exist in that portion.

When manufacturing the lithium ion battery 1, sealing 203 being welding processing or caulking is performed on the members constituting the accommodation case 10, resulting in that the iron exposed portion is generated at a surface of the accommodation case 10 that may be brought into contact with the atmosphere. Further, by the sealing processing as above, the main body part 11 and the lid part 13, 13A of the accommodation case 10 are integrated, and the lid part 13A and the liquid pouring port lid 17 are integrated.

### <Regarding Coating Film Part 30>

As has been mentioned above, a case is supposed in which, when pouring the electrolytic solution containing a lithium salt containing fluorine, a part of the electrolytic solution is adhered to the iron exposed portion as described above. If, in such a case, the lithium salt containing fluorine and the moisture in the atmosphere react with each other, hydrofluoric acid is generated, and the generated hydrofluoric acid corrodes the iron exposed portion to generate red rust. Accordingly, in the lithium ion battery according to the present embodiment, the iron exposed portion in the sealing portion as above is dealt as a portion to be coated 201, and the coating film part 30 is provided to such a portion to be coated 201. Therefore, when seen from the manufactured lithium ion battery 1, it can be said that the portion at which the coating film part 30 exists, is a portion dealt as the portion to be coated 201, in the manufacturing process of the lithium ion battery 1.

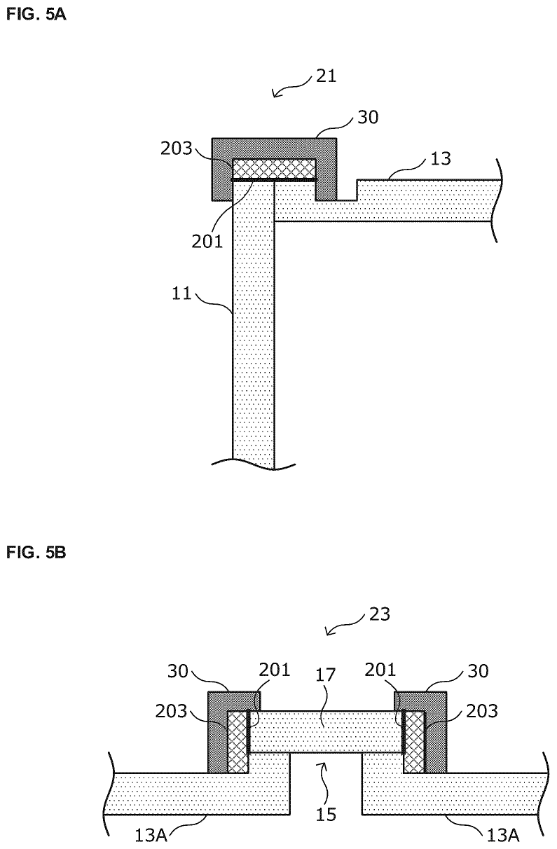

Hereinafter, the coating film part 30 in the lithium ion battery 1 according to the present embodiment will be explained in detail while referring to FIG. 5A and FIG. 5B. Each of FIG. 5A and FIG. 5B is an explanatory view schematically illustrating the lithium ion battery 1 according to the present embodiment. FIG. 5A schematically illustrates a part of a cross section obtained by cutting the accommodation case 10 in the case height direction, and FIG. 5B schematically illustrates a part of a cross section obtained by cutting the vicinity of the liquid pouring port lid 17 of the accommodation case 10 in the case height direction.

As exemplified in FIG. 5A and FIG. 5B, in the lithium ion battery 1 according to the present embodiment, the coating film part 30 is provided on the portion to be coated 201, so as to cover the portion to be coated 201 (or the sealing 203 that exists at the portion to be coated 201). Such a coating film part 30 contains at least any of the Ca compound and the Al compound.

The Ca compound, the Al compound, and the La compound react with hydrofluoric acid (HF) to form fluorides (CaF₂, AlF₃, LaF₃), which can render the hydrofluoric acid harmless. For this reason, by providing the coating film part 30 containing at least any of the Ca compound, the Al compound, and the La compound on the portion to be coated 201 (or on the sealing 203 that exists at the portion to be coated 201), even in a case where the electrolytic solution has been adhered to the portion to be coated 201, it becomes possible to render the generated hydrofluoric acid harmless, to thereby prevent the generation of red rust. Consequently, in the lithium ion battery 1 according to the present embodiment, even in a case where the electrolytic solution has been adhered to the outer surface of the lithium ion battery 1, it becomes possible to keep the outer surface corrosion resistance of the lithium ion battery 1.

Here, as the Ca compound, the Al compound, and the La compound, various kinds of compounds can be used as long as they are compounds capable of forming fluorides by being reacted with hydrofluoric acid, and they themselves do not promote the corrosion of the Ni-plated steel sheet 100. From the viewpoint that the compounds themselves do not promote the corrosion of the Ni-plated steel sheet 100, CaCl₂) and AlCl₃, for example, are excluded from candidates of such compounds.

As the Ca compound, the Al compound, and the La compound as above, there can be cited, for example, a hydroxide of Ca, Al, or La, a salt of an anion that is not a strong acid anion, and a Ca ion, an Al ion, or a La ion (for example, a carbonate of Ca, Al, or La), or an oxide of Ca, Al, or La. The Ca compound, the Al compound, and the La compound as above are more preferably ones in which reaction products thereof with hydrofluoric acid do not have corrosiveness with respect to Fe and Ni.

There can be cited, as the Ca compound as above, a calcium carbonate (CaCO₃), a calcium oxide (CaO), and a calcium hydroxide (Ca(OH)₂), for example, there can be cited, as the Al compound, an aluminum carbonate (Al₂(CO₃)₃), an aluminum oxide (Al₂O₃), and an aluminum hydroxide (Al(OH)₃), and there can be cited, as the La compound, a lanthanum carbonate (La₂(CO₃)₃), a lanthanum oxide (La₂O₃), and a lanthanum hydroxide (La(OH)₃), for example. These compounds may be used independently or in combination.

Further, in the Ca compound to be contained in such a coating film part 30, 80 mass % or more in terms of metal Ca is preferably the calcium hydroxide. The proportion of calcium hydroxide in the Ca compound is more preferably 90 mass % or more. By creating such a state, it is possible to further improve the outer surface corrosion resistance in the first sealing portion 21 and the second sealing portion 23.

Such a coating film part 30 may be constituted of at least any of the Ca compound, the Al compound, and the La compound, and it may also be constituted in a state where at least any of the Ca compound, the Al compound, and the La compound is dispersed in a resin. As the resin that functions as a binder when dispersing the Ca compound, the Al compound, or the La compound in the resin, various kinds of resin can be used. As such a resin, there can be cited, for example, PVDF (Poly Vinylidene DiFluoride), an epoxy resin, a melamine resin, a silicone resin, an acrylic resin, and a polyurethane resin.

The coating film part 30 according to the present embodiment can be formed in a manner that a treatment agent containing at least any of the Ca compound, the Al compound, and the La compound as described above, or further containing the resin as described above according to need is prepared, and the portion to be coated 201 (or the portion to be coated 201 that exists at the sealing 203) is coated with such a treatment agent and then dried. Note that it is important that the coating of the treatment agent as described above is performed after the battery unit 3 and the electrolytic solution 5 are accommodated in the accommodation case 10 and then the sealing processing is performed, as will be explained again hereinbelow, and it does not mean that the coating of the treatment agent as described above may be performed in advance of the sealing processing.

Note that in order to specify, in an ex-post manner, the portion provided with the coating film part 30 regarding the already-manufactured lithium ion battery 1, the following may be performed. First, the entire focused lithium ion battery is embedded in a resin, the entire lithium ion battery is then cut in a longitudinal direction of the accommodation case 10 at a position of a portion passing through a center of a short side of the lithium ion battery, or a position of a portion passing through a center of the liquid pouring port when the liquid pouring port exists, to thereby obtain a cross-section observation sample. The obtained cross-section observation sample is appropriately polished, and the obtained cross section is observed with a scanning electron microscope (SEM). As this time, a size of a visual field when performing the observation may be set to 1000 μm×1000 μm. At this time, it is possible to specify the presence/absence of the coating film part 30 based on a difference in the way of visual recognition of each structure in the visual field.

Further, in order to verify, in an ex-post manner, regarding whether or not the coating film part 30 specified as described above is provided on the portion with the content of Fe of 80 mass % or more (specifically, the above-described portion to be coated 201) of the first sealing portion 21 or the second sealing portion 23, the following may be performed. Specifically, the cross section of the cross-section observation sample obtained as described above may be observed with an EDS (Energy Dispersive X-ray Spectrometry) (for example, JSM-7000F manufactured by JEOL Ltd.) mounted on a scanning electron microscope, to thereby perform a mapping analysis regarding a distribution state of each element. By comparing the cross-section observation result as described above with the mapping analysis result regarding the element Fe, for example, it is possible to determine whether or not the coating film part 30 specified as described above is provided to the portion with the content of Fe of 80 mass % or more, of the first sealing portion 21 or the second sealing portion 23. Here, it is set that the measurement condition for the cross-section observation and the mapping analysis as described above includes an acceleration voltage of 15 kV, and an irradiation current of 7.47500 nA.

Further, in order to check, in an ex-post manner, the presence/absence of the Ca compound, the Al compound, and the La compound in the coating film part 30, a powder sample may be collected from the coating film part 30, and the obtained powder sample may be analyzed through an X-ray diffraction analysis method. More specifically, it is possible that a powder sample of 5 g is collected from an arbitrary position of the coating film part 30, and then an analysis is performed by a commercially available X-ray diffraction analyzer (for example, RINT-TTR3 manufactured by Rigaku Corporation), to thereby check whether or not peaks derived from Ca, Al, and La exist in the measured results. In like manner, regarding whether the resin is contained in the coating film part 30, it is only required to check whether or not the peak derived from C (carbon) exists in the measured results. Further, in order to specify, in an ex-post manner, compound names of the Ca compound, the Al compound, and the La compound contained in the coating film part 30, the peaks that exist in the measurement may be assigned, to thereby specify the compound names. At this time, Cu may be used as an X-ray source, and the measurement condition may include an X-ray output of 50 kV and 300 mA, a scan speed of 1 deg/min, a step width of 0.01 deg, a scan axis of 2Theta/Theta, a scan range of 5 to 100 deg, an entrance slit of ½°, and a length limiting slit of 5 mm.

Further, in the coating film part 30 according to the present embodiment, the Ca compound, the Al compound, or the La compound and hydrofluoric acid are reacted with each other to render the hydrofluoric acid harmless, as described above, so that as products of such a reaction, a fluoride of Ca, Al, or La (specifically, CaF₂, AlF₃, or LaF₃) is generated. For this reason, the coating film part 30 of the lithium ion battery 1 according to the present embodiment may contain the fluoride as the Ca compound, the Al compound, or the La compound.

Specifically, the coating film part 30 of the lithium ion battery 1 according to the present embodiment is sometimes constituted of a compound other than the fluoride of at least any of Ca, Al, and La, it is sometimes constituted of the compound other than the fluoride of at least any of Ca, Al, and La, and the fluoride of at least any of Ca, Al, and La, and it is sometimes constituted of the fluoride of at least any of Ca, Al, and La. Here, the presence/absence of the fluoride of Ca, Al, or La can be checked by collecting a powder sample from the coating film part 30, and analyzing the obtained powder sample through the X-ray diffraction analysis method. More specifically, it is possible that a powder sample of 5 g is collected from an arbitrary portion of the coating film part 30, and then an analysis is performed by a commercially available X-ray diffraction analyzer (for example, RINT-TTR3 manufactured by Rigaku Corporation), to thereby check whether or not peaks derived from Ca, Al, La, and F exist in the measured results. At this time, Cu may be used as an X-ray source, and the measurement condition may include an X-ray output of 50 kV and 300 mA, a scan speed of 1 deg/min, a step width of 0.01 deg, a scan axis of 2Theta/Theta, a scan range of 5 to 100 deg, an entrance slit of ½°, and a length limiting slit of 5 mm.

The fluoride of Ca, Al, or La is a reaction product between the Ca compound, the Al compound, or the La compound, and hydrofluoric acid. For this reason, such a fluoride exists more on a side of interface with the portion to be coated 201 or the sealing 203 than on a side of surface of the coating film part 30. In other words, in the coating film part 30 according to the present embodiment, the fluoride of Ca or Al is unevenly distributed so that the fluoride exists more on a side of interface with the base steel sheet constituting the Ni-plated steel sheet 100, or the sealing 203.

In such a coating film part 30, the total adhesion amount of the Ca compound in terms of metal Ca, the Al compound in terms of metal Al, and the La compound in terms of metal La, is preferably 0.001 g/m² or more, based on the total converted values thereof. When the total adhesion amount of the Ca compound, the Al compound, and the La compound becomes 0.001 g/m² or more, it becomes possible to make the effect of rendering the hydrofluoric acid harmless as described above exhibit stably, and it is possible to further improve the outer surface corrosion resistance of the first sealing portion 21 and the second sealing portion 23. The total adhesion amount of the Ca compound, the Al compound, and the La compound is more preferably 100.000 g/m² or more, and still more preferably 300.000 g/m² or more.

On the other hand, in the coating film part 30, the total adhesion amount of the Ca compound in terms of metal Ca, the Al compound in terms of metal Al, and the La compound in terms of metal La, is preferably 1000.000 g/m² or less, based on the total converted values thereof. There is a case where the portion to be coated 201 (or the sealing 203 that exists at the portion to be coated 201) is coated with the Ca compound, the Al compound, or the La compound in a state of paste, so that the total adhesion amount may become about 1000.000 g/m². Further, when the total adhesion amount of the Ca compound, the Al compound, and the La compound becomes 1000.000 g/m² or less, it is possible to further improve the outer surface corrosion resistance of the first sealing portion 21 and the second sealing portion 23 while suppressing the increase in manufacturing cost. The total adhesion amount of the Ca compound, the Al compound, and the La compound differs depending also on the constitution and the forming method of the coating film part 30.

For example, in a case of the coating film part 30 formed by being coated with at least any of the Ca compound, the Al compound, and the La compound (specifically, the paste of the Ca compound, the Al compound, or the La compound), the total adhesion amount of the Ca compound, the Al compound, and the La compound is more preferably 800.000 g/m² or less, and still more preferably 500.000 g/m² or less. Further, in a case of the coating film part 30 formed by being coated with paint obtained by making the Ca compound, the Al compound, or the La compound to be dispersed in the resin, the total adhesion amount of the Ca compound, the Al compound, and the La compound is more preferably 800.000 g/m² or less, and still more preferably 500.000 g/m² or less.

Further, depending on cases, there can be considered a situation where an excess portion of the coating film part 30 after being subjected to the reaction with hydrofluoric acid is removed and then the lithium ion battery is shipped. Also in such a case, the total adhesion amount of the Ca compound, the Al compound, and the La compound may more preferably become about 100.000 g/m² or less.

Further, in the coating film part 30, the adhesion amount of the fluoride in terms of fluorine being the reaction product may become greater than 0 g/m². On the other hand, when considering the amount of electrolytic solution that may be adhered to the first sealing portion 21 and the second sealing portion 23, the adhesion amount of the fluoride in terms of fluorine that may exist in the coating film part 30 substantially becomes 0.200 g/m² or less.

Here, the total adhesion amount of the Ca compound, the Al compound, and the La compound in the coating film part 30 can be measured through the ICP emission spectrochemical analysis method. First, as a sample, the coating film part 30 having a size of 1 mm×50 mm in plan view is collected from arbitrary five locations, and the obtained samples are respectively dissolved by sulfuric acid. Next, a Ca amount, an Al amount, and a La amount contained in each dissolved solution are subjected to a quantitative analysis by using a commercially available ICP emission spectrochemical analyzer (for example, ICPS-8100 manufactured by SHIMADZU CORPORATION). The Ca amount, the Al amount, and the La amount obtained through such a quantitative analysis correspond to a converted amount in terms of Ca, a converted amount in terms of Al, and a converted amount in terms of La, respectively. For this reason, by dividing the total of the obtained Ca amount, Al amount, and La amount by the above-described area, it is possible to determine the total adhesion amount of the Ca compound, the Al compound, and the La compound. An average value of the obtained five total adhesion amounts of the Ca compound, the Al compound, and the La compound, is dealt as the total adhesion amount of the Ca compound, the Al compound, and the La compound.

The adhesion amount of the fluoride in the coating film part 30 can be measured in the following manner.

First, as a sample, the coating film part 30 having a size of 1 mm×50 mm in plan view is collected from arbitrary five locations, and the obtained samples are respectively dissolved by sulfuric acid. Gases generated during such dissolution are respectively analyzed by a commercially available gas chromatograph (for example, Nexis GC-2030 manufactured by SHIMADZU CORPORATION), to thereby measure an F amount. By dividing the obtained F amount by the above-described area, it is possible to determine the adhesion amount of the fluoride. An average value of the obtained five adhesion amounts of the fluoride, is dealt as the adhesion amount of the fluoride. Accordingly, it is possible to obtain the adhesion amount of the fluoride in terms of fluorine.

Further, a proportion occupied by the calcium hydroxide in the Ca compound contained in the coating film part 30 can be specified in the following manner.

Specifically, it is assumed that all of F bonds to Ca in the sample having the coating film part 30 containing the calcium hydroxide. On that condition, the measurement of F amount is performed regarding the collected sample, in a similar manner to the above. Based on the F amount obtained through the measurement as above, the Ca amount is converted based on the above assumption. A difference between the total adhesion amount of the Ca compound and the converted Ca amount becomes the Ca amount of the calcium hydroxide. By dividing the obtained Ca amount of the calcium hydroxide by the total adhesion amount of the Ca compound, it is possible to calculate the proportion occupied by the calcium hydroxide.

Further, an uneven distribution state of the fluoride in the coating film part 30 can be checked as follows, for example. First, from the coating film part 30 of a long side part of the accommodation case 10, a cross-section observation sample is cut out. At this time, a cutting direction for obtaining the cross section is set to a direction perpendicular to the longitudinal direction of the accommodation case 10. It is possible that the obtained cross-section observation sample is embedded in a resin, polishing is then appropriately performed, and the obtained cross section is observed with a scanning electron microscope (SEM), to thereby perform measurement. As this time, a size of a visual field when performing the observation may be set to 1000 μm×1000 μm. More specifically, the cross section of the cross-section observation sample obtained as described above is observed with an energy dispersive X-ray spectrometry (EDS) (for example, JSM-7000F manufactured by JEOL Ltd.) mounted on a scanning electron microscope, to perform a mapping analysis regarding a distribution state of each element, which makes it possible to check the uneven distribution state of the fluoride.

At this time, when a position at which a concentration of the fluoride reaches a peak in the obtained mapping result regarding the element F is on the base steel sheet side relative to a position of half a thickness of the coating film part 30, it is determined that the fluoride “is in an uneven distribution state”. Here, it is set that the measurement condition for the mapping analysis includes an acceleration voltage of 15 kV, and an irradiation current of 7.47500 nA. Further, regarding the thickness of the coating film part 30, a portion in which the element F exists is specified from the obtained mapping result, and a length of the specified portion may be measured by using a length measuring function mounted on an image analysis application. It is possible that the measurement as above is performed at arbitrary five locations of the focused cross section, the obtained measured values are averaged by the number of measurement locations, and the result thereof is set to the thickness of the coating film part 30.

Note that it is also possible to perform an element analysis of the coating film part 30 by the above-described analysis method using SEM-EDS.

The lithium ion battery 1 according to the present embodiment has been explained above in detail while referring to FIG. 1A to FIG. 5B.

### Second Embodiment

### <Regarding Material of Accommodation Case 10>

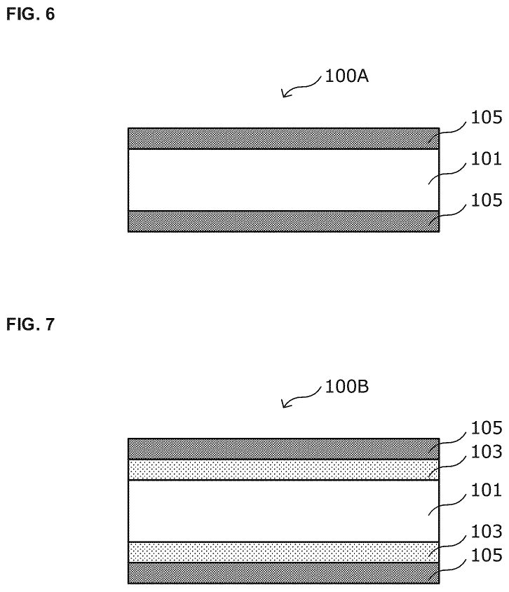

Next, a material of the accommodation case 10 according to a second embodiment of the present invention will be explained in detail while referring to FIG. 6. FIG. 6 is an explanatory view schematically illustrating the material of the accommodation case of the lithium ion battery according to the present embodiment.

As the material of the accommodation case 10 according to the present embodiment, a Ni-plated steel sheet or a laminated steel sheet is used. Hereinafter, a case will be explained in which the laminated steel sheet is used as the material of the accommodation case 10 according to the present embodiment.

FIG. 6 schematically illustrates a layer structure of a laminated steel sheet 100A.

The laminated steel sheet 100A used as the material of the accommodation case 10 has a base steel sheet 101, and surface-treated layers 105 provided on surfaces of the base steel sheet 101, as illustrated in FIG. 6.

Here, as the base steel sheet 101, one similar to the base steel sheet 101 of the Ni-plated steel sheet 100 explained before can be used, and thus a detailed explanation thereof will be omitted below.

The surface-treated layer 105 is a layer formed by laminating the surface of the base steel sheet 101 with various kinds of resin. As such a surface-treated layer 105, it is possible to adopt various kinds of surface-treated layers as long as they exhibit the corrosion resistance with respect to the electrolytic solution 5 kept in the accommodation case 10. As the resin constituting such a surface-treated layer 105, there can be cited, for example, a polypropylene (PP) resin, a polyethylene terephthalate (PET) resin, and a polyethylene (PE) resin. These resins may be used independently, or a plurality of them may be used in combination.

A thickness per side of the surface-treated layer 105 is preferably, for example, 10 to 150 μm. The thickness per side of the surface-treated layer 105 of 50 μm or more is more preferable since it becomes possible to further improve the corrosion resistance of the laminated steel sheet 100A. On the other hand, the thickness per side of the surface-treated layer 105 of 100 μm or less is more preferable since it becomes possible to further reduce the manufacturing cost of the laminated steel sheet 100A.

Note that in order to determine, in an ex-post manner, the presence/absence of the surface-treated layer 105, the ICP emission spectrochemical analysis method may be used, for example. First, from arbitrary five locations of a bottom surface of an accommodation case of a focused lithium ion battery, samples each having a size of 30 mm×30 mm in plan view are respectively cut out, and respective surface-treated layers 105 that exist in such samples are dissolved with acid (more specifically, 19% hydrochloric acid). Next, an attention is focused on an element capable of being contained in the surface-treated layer 105, and the respective samples are subjected to a quantitative analysis by using an ICP emission spectrochemical analyzer (for example, ICPS-8100 manufactured by SHIMADZU CORPORATION). For example, an attention is focused on a carbon (C) element contained in the resin that constitutes the surface-treated layer 105, and a Total-C amount contained in the dissolved solution is subjected to the quantitative analysis. For example, when an average value of the obtained five Total-C amounts indicates a value greater than 0, it can be determined that the surface-treated layer 105 existed in the focused laminated steel sheet 100A. Note that in a case where, at the time of cutting out the sample from the focused location, the size of any side of the sample becomes less than 30 mm, it is only required to cut out the sample from the focused location so that an area of the sample becomes 90 mm².

Further, the thickness of the surface-treated layer 105 can be specified by observing a cross section of the laminated steel sheet 100A with the scanning electron microscope (SEM). Specifically, from an arbitrary portion of the laminated steel sheet 100A, a cross-section observation sample is cut out. At this time, a cutting direction for obtaining the cross section is set to a sheet thickness direction of the laminated steel sheet 100A. The obtained cross-section observation sample is polished, and then SEM photographs are taken at arbitrary five locations of such a cross section. The thicknesses of the surface-treated layers 105 measured in the obtained respective SEM photographs are averaged by the number of measurement locations, and the obtained average value may be set to the thickness of the surface-treated layer 105.

Further, in the laminated steel sheet 100A as described above, various kinds of conversion treatment coating layer (not illustrated) may further exist between the base steel sheet 101 and the surface-treated layer 105. When such a conversion treatment coating layer exists, it becomes possible to further improve the adhesiveness between the base steel sheet 101 and the surface-treated layer 105. Further, when such a conversion treatment coating layer exists, it becomes possible to further improve the corrosion resistance of the laminated steel sheet 100A.

Regarding the relation between the sealing processing and the portion to be coated with the coating film part, and the coating film part 30 in the case of using the laminated steel sheet 100A as the material of the accommodation case 10, in the explanation of the corresponding part in the first embodiment, the description of “the Ni-plated steel sheet 100” may be read as “the laminated steel sheet 100A”, and the description of “the Ni-plating layer 103” may be read as “the surface-treated layer 105”. For this reason, a detailed explanation regarding the relation between the sealing processing and the portion to be coated with the coating film part, and the coating film part 30 in the case of using the laminated steel sheet 100A as the material of the accommodation case 10, will be omitted below.

### Third Embodiment

### <Regarding Material of Accommodation Case 10>

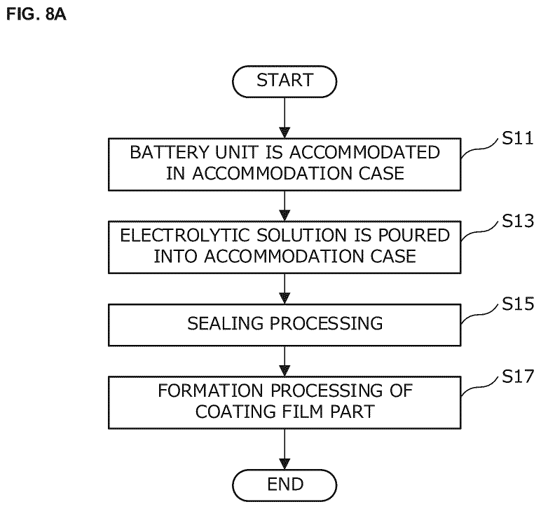

Next, a material of an accommodation case 10 according to a third embodiment of the present invention will be explained in detail while referring to FIG. 7. FIG. 7 is an explanatory view schematically illustrating the material of the accommodation case of the lithium ion battery according to the present embodiment.

As the material of the accommodation case 10, it is also possible to use a surface-treated steel sheet 100B obtained by forming Ni-plating layers 103 and surface-treated layers 105 on surfaces of a base steel sheet 101, as illustrated in FIG. 7.

Here, the Ni-plating layer 103 in such a surface-treated steel sheet 100B has a constitution similar to that of the Ni-plating layer 103 in the Ni-plated steel sheet 100 according to the first embodiment and exhibits a similar effect, and thus a detailed explanation thereof will be omitted below. Further, the surface-treated layer 105 in such a surface-treated steel sheet 100B has a constitution similar to that of the surface-treated layer 105 in the laminated steel sheet 100A according to the second embodiment and exhibits a similar effect, and thus a detailed explanation thereof will be omitted below.

Further, in the surface-treated steel sheet 100B as described above, various kinds of conversion treatment coating layer (not illustrated) may further exist at least between the base steel sheet 101 and the Ni-plating layer 103, or between the Ni-plating layer 103 and the surface-treated layer 105. When such a conversion treatment coating layer exists, it becomes possible to further improve the adhesiveness between the base steel sheet 101 and the Ni-plating layer 103, and the adhesiveness between the Ni-plating layer 103 and the surface-treated layer 105. Further, when such a conversion treatment coating layer exists, it becomes possible to further improve the corrosion resistance of the surface-treated steel sheet 100B.

Regarding the relation between the sealing processing and the portion to be coated with the coating film part, and the coating film part 30 in the case of using the surface-treated steel sheet 100B as the material of the accommodation case 10, in the explanation of the corresponding part in the first embodiment, the description of “the Ni-plated steel sheet 100” may be read as “the surface-treated steel sheet 100B”, and the description of “the Ni-plating layer 103” may be read as “the surface-treated layer 105, or both the Ni-plating layer 103 and the surface-treated layer 105”. For this reason, a detailed explanation regarding the relation between the sealing processing and the portion to be coated with the coating film part, and the coating film part 30 in the case of using the surface-treated steel sheet 100B as the material of the accommodation case 10, will be omitted below.

### (Regarding Manufacturing Method of Lithium Ion Battery)

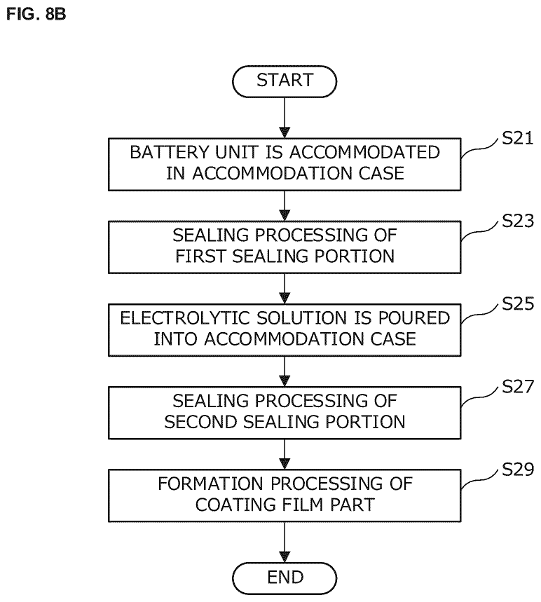

Next, one example of a manufacturing method of the lithium ion battery according to each embodiment of the present invention will be explained while referring to FIG. 8A and FIG. 8B. Each of FIG. 8A and FIG. 8B is a flow chart illustrating one example of a flow of the manufacturing method of the lithium ion battery according to each embodiment of the present invention.

Previous to the explanation below, it is assumed that the main body part 11 and the lid parts 13, 13A of the accommodation case 10 are already manufactured to have desired shapes by using the Ni-plated steel sheet 100, the laminated steel sheet 100A, or the surface-treated steel sheet 100B.

FIG. 8A illustrates a manufacturing method of the lithium ion battery 1 in a case where there exists either of the first sealing portion 21 being a sealing portion between the main body part 11 and the lid part 13, and the second sealing portion 23 being a sealing portion between the liquid pouring port lid 17 for sealing the liquid pouring port 15 provided to the lid part 13A, and the liquid pouring port 15.

As illustrated in FIG. 8A, in the manufacturing method of the lithium ion battery 1 as described above, the battery unit 3 is first accommodated in the accommodation case 10 (step S11), and then the electrolytic solution 5 is poured into the accommodation case 10 (step S13). After that, a sealing method such as welding or caulking is used to perform sealing processing between the main body part 11 and the lid part 13, or between the liquid pouring port lid 17 and the liquid pouring port 15 of the accommodation case (step S15).

FIG. 8B illustrates a manufacturing method of the lithium ion battery in a case where there exist the first sealing portion 21 being a sealing portion between the main body part 11 and the lid part 13A, and the second sealing portion 23 being a sealing portion between the liquid pouring port lid 17 for sealing the liquid pouring port 15 provided to the lid part 13A, and the liquid pouring port 15.

As illustrated in FIG. 8B, in the manufacturing method of the lithium ion battery 1 as described above, the battery unit 3 is first accommodated in the accommodation case 10 (step S21), and after that, a sealing method such as welding or caulking is used to perform sealing processing between the main body part 11 and the lid part 13A of the accommodation case 10 (step S23). After that, the electrolytic solution 5 is poured into the accommodation case 10 via the liquid pouring port 15 (step S25). Subsequently, a sealing method such as welding or caulking is used to perform sealing processing between the liquid pouring port lid 17 and the liquid pouring port 15 (step S27).

Consequently, the main body part 11 and the lid part 13, 13A of the accommodation case 10 are integrated, resulting in that there exist the first sealing portion 21 and the second sealing portion 23 as explained before.

Here, as the method of accommodating the battery unit 3 in the accommodation case 10, the method of pouring the electrolytic solution 5 into the accommodation case 10, and the sealing method, publicly-known various kinds of methods may be appropriately adopted.

However, when the reaction between the electrolytic solution that may be adhered to the outer surface of the accommodation case 10 and the moisture in the atmosphere is taken into consideration, the step up to the step of performing the sealing processing as described above, is preferably conducted under an atmosphere in which the amount of moisture becomes small as much as possible (under an atmosphere of a dew point of −75° C. or less, for example). In other words, it is preferable that the accommodation case 10 is at least taken out into the atmosphere after the sealing processing under the atmosphere as described above is terminated.

Next, coating treatment for forming the coating film part 30 is performed on a portion with an Fe content ratio of 80 mass % or more (specifically, the portion to be coated 201), of the first sealing portion 21 and the second sealing portion 23 formed according to FIG. 8A and FIG. 8B, for example (step S17, step S29). When performing the coating treatment as above, paint containing at least any of the Ca compound, the Al compound, and the La compound as explained before is prepared, and the coating of the paint is performed so that the adhesion amount after drying satisfies the range as explained before.

The paint as above may be one obtained by making at least any of the Ca compound, the Al compound, and the La compound to be dissolved or dispersed in various kinds of organic solvent, or it may also be one obtained by making at least any of the Ca compound, the Al compound, and the La compound to be dispersed in various kinds of resin. Note that when using the organic solvent, it is preferable to use carbonic acid esters contained in the electrolytic solution, such as dimethyl carbonate (DMC), ethyl methyl carbonate (EMC), diethyl carbonate (DEC), propylene carbonate (PC), and ethylene carbonate (EC).

Further, the coating treatment as above is preferably conducted under the atmosphere in which the amount of moisture is small as much as possible (under the atmosphere of the dew point of −75° C. or less, for example). From such a viewpoint, it is more preferable that the coating treatment of the paint as described above is continuously performed under the atmosphere in which the sealing processing as described above was performed. Further, in a case where the coating treatment is performed under an atmosphere in which a certain amount of moisture exists (a case where the sealing processing as described above is terminated, and then the accommodation case 10 after being subjected to the sealing is taken out into the atmosphere, for example), it is preferable to perform the coating treatment as early as possible after the sealing processing.

Note that as the method of coating the portion to be coated 201 with the paint, publicly-known various kinds of coating methods can be adopted.

After the coating of the paint as described above, the coated paint is dried and solidified, resulting in that the coating film part 30 is formed on the portion to be coated 201 of the lithium ion battery 1. Since such a coating film part 30 is formed, even in a case where the electrolytic solution is adhered to the outer surface of the lithium ion battery 1 and the lithium ion battery 1 is exposed to the atmosphere, it is possible to prevent the generation of red rust derived from hydrofluoric acid.

Note that removal processing of the excess coating film part 30, and the like may also be performed according to need after drying and solidifying the paint.

The manufacturing method of the lithium ion battery 1 according to each embodiment of the present invention has been explained above while referring to FIG. 8A and FIG. 8B.

### EXAMPLE

Hereinafter, the lithium ion battery according to the present invention will be concretely explained while describing examples and comparative examples. Note that the examples to be described below are merely examples of the lithium ion battery according to the present invention, and the lithium ion battery according to the present invention is not limited to the following examples.

### Test Example

In test examples to be described below, a main body part and a lid part of an accommodation case were prepared, and a battery unit to be described below was prepared, and these members were assembled to obtain a lithium ion battery. An electrolytic solution was poured from an opening portion provided to the main body part of the accommodation case, the main body part was then sealed by the lid part, and the completed lithium ion battery was evaluated regarding its outer surface corrosion resistance.

### <Main Body Part and Lid Part of Accommodation Case>

Ni-plated steel sheet

As a Ni-plated steel sheet, a nickel-plated steel sheet (SUPERNICKEL (registered trademark)) manufactured by NIPPON STEEL CORPORATION was used. In such a nickel-plated steel sheet, a Ni adhesion amount per side was 2.0 μm.
Laminated steel sheet
   Base steel sheet: Tinfree steel (CANSUPER (registered trademark)) manufactured by NIPPON STEEL CORPORATION
   Surface-treated layer: PP (battery inner face side (side facing battery unit))/PET (battery outer surface side)

Each resin film formed of the above-described resin was prepared, and the resin film was pressed against the tinfree steel heated to 200° C. to be fused, thereby producing the laminated steel sheet. Note that a thickness of the thermally fused surface-treated layer was 50 μm.
Surface-treated steel sheet

Further, one similar to the surface-treated layer provided to the above-described laminated steel sheet was similarly formed on front and rear surfaces of the above-described nickel-plated steel sheet manufactured by NIPPON STEEL CORPORATION, to thereby obtain the surface-treated steel sheet.

The nickel-plated steel sheet, the laminated steel sheet, and the surface-treated steel sheet as described above were used, to produce the main body part and the lid part of the accommodation case. Note that the main body part and the lid part of the accommodation case were set to have shapes similar to those of the accommodation case exemplified in FIG. 1A.

### <Battery Unit>

Positive electrode plate

As a positive electrode active material, lithium cobaltate was used. Such a positive electrode active material, acetylene black, and polyvinylidene difluoride (PVDF) were mixed to satisfy, in mass ratio, lithium cobaltate:acetylene black:PVDF=10:10:1. After that, Al foil was coated with the mixture as aqueous dispersion and then dried. The obtained one was rolled to a predetermined thickness and cut out to a predetermined size, to thereby obtain the positive electrode plate.
Negative electrode plate

As a negative electrode active material, amorphous carbon was used. The amorphous carbon was dry-mixed with acetylene black being a conductive material to obtain a mixture. After that, N-methyl-2-pyrrolidone (NMP) into which polyvinylidene difluoride was dissolved, was uniformly dispersed in the mixture, thereby producing a paste containing, in mass ratio, carbon:acetylene black:PVDF=88:5:7. Cu foil was coated with the obtained paste and dried, and the resultant was then rolled to a predetermined thickness and cut out to a predetermined size, to thereby obtain the negative electrode plate.
Separator

As a separator, a polyethylene micro-porous film was used.

### <Electrolytic Solution>

As an electrolytic solution, a solution obtained by adding 1 mol/L of lithium phosphate hexafluoride to a mixture obtained by mixing ethylene carbonate and diethyl carbonate in a volume ratio of 1:1 (1 M-LiPF₆ EC/DEC (1/1)) was used.

### <Manufacturing Procedure of Lithium Ion Battery>

The separator was sandwiched between the positive electrode plate and the negative electrode plate obtained as described above, and then the resultant was wound to obtain a battery unit. Such the battery unit was flattened into a shape capable of being inserted into an inner space of a main body part of an accommodation case, and after that, the positive electrode plate was welded to an Al lead, and the negative electrode plate was welded to a Ni lead. The Al lead was welded to a positive electrode terminal provided to a lid part of the accommodation case, and the Ni lead was welded to a negative electrode terminal provided to the lid part of the accommodation case.

The inside of the battery was dried under an atmosphere of a dew point of −75° C., to thereby remove the moisture. After that, under the same atmosphere, the above-described electrolytic solution was poured from an opening portion provided to the main body part of the accommodation case. After that, the lid part was fixed to the main body part through welding or seaming. Thereafter, under the same atmosphere, the obtained lithium ion battery was charged at 3.6 V. By the processing as above, the moisture remained in the battery was electrolyzed and removed. After that, under the same atmosphere, a metal of a type same as that of the lid part was welded, as a liquid pouring port lid, to a liquid pouring port, to thereby obtain a complete body of the lithium ion battery.

### <Corrosion Resistance Evaluation>

Preparation of evaluation sample

In order to simulate a situation in which the electrolytic solution is adhered to the outer surface regarding the lithium ion battery obtained as described above, the sealing portion between the main body part and the lid part (specifically, the first sealing portion) was coated with the above-described electrolytic solution (LiPF₆+EC/DEC) by a brush, under an atmosphere of a dew point of −75° C.
Rust proof treatment: formation of coating film part

Under the atmosphere of the dew point of −75° C. or at a timing as early as possible from when the sample was taken out into the atmosphere, the sealing portion (the first sealing portion) of the above-described evaluation sample was coated with “a mixture of an organic solvent and a Ca compound, an Al compound, or a La compound”, “a mixture of a resin and a Ca compound, an Al compound, or a La compound”, or “only a resin” shown in Table 1 below, as a rust proof treatment agent, by a brush, and then dried. This makes it possible to form a coating film part corresponding to each rust proof treatment agent on the first sealing portion.

Here, the used Ca compound, Al compound, La compound, organic solvent, and resin are respectively as follows, and each of them is one similar to a commercially available general reagent.
Ca compound: calcium hydroxide, calcium carbonate, calcium hydrogen carbonate, calcium oxide
Al compound: aluminum hydroxide, calcium carbonate, aluminum oxide
La compound: lanthanum hydroxide, lanthanum carbonate, lanthanum oxide
Organic solvent: dimethyl carbonate (DMC), ethyl methyl carbonate (EMC), diethyl carbonate (DEC), propylene carbonate (PC), ethylene carbonate (EC)
Resin: PVDF, epoxy resin, melamine resin, silicone resin, acrylic resin, polyurethane resin
Evaluation method

Each of the evaluation samples after being subjected to the rust proof treatment as described above was retained under the air atmosphere (specifically, under the atmosphere where the moisture exists). An external appearance was observed one month after the start of retention, to thereby observe the presence/absence of the generation of red rust. A red rust generation rate was calculated from an area of the first sealing portion and a red rust generation state obtained from the observation, and an evaluation was performed based on the following evaluation criteria. The following scores “A” to “C” were set as acceptable.
Score “A”: Red rust generation rate of 0%
Score “B”: Red rust generation rate of greater than 0% and 1% or less
Score “C”: Red rust generation rate of greater than 1% and 5% or less
Score “D”: Red rust generation rate of greater than 5%
Analysis regarding coating film part

A sample was collected from the coating film part of each of the evaluation samples after checking the presence/absence of red rust generation. Regarding the sample corresponding to the rust proof treatment agent using the organic solvent, powder was collected from the first sealing portion by a brush. Further, regarding the sample corresponding to the rust proof treatment agent using the resin, the first sealing portion was partially scraped off to be collected, and then frozen and pulverized to be turned into a powder state.

Regarding each powder collected as described above, the total adhesion amount of the Ca compound, the Al compound, and the La compound, the proportion of calcium hydroxide occupied in the Ca compound, the presence/absence of the fluoride, and the adhesion amount of the fluoride were respectively analyzed based on the methods explained before. The used ICP emission spectrochemical analyzer is ICPS-8100 manufactured by SHIMADZU CORPORATION, and the used gas chromatograph is Nexis GC-2030 manufactured by SHIMADZU CORPORATION.

Further, from a portion different from the above-described portion of obtaining the powder, a cross-section observation sample was cut out, and a distribution state of the fluoride was checked based on the method explained before. When a peak of the fluoride was on the steel sheet side relative to a position of half a thickness of the coating film part, it was evaluated that the fluoride was in a state of “being unevenly distributed”. In the following Table 1, when the fluoride is in a state of “being unevenly distributed”, it is indicated as “YES”.

Note that the cross-section observation sample was obtained by cutting, with a high-speed and high-precision cutting machine, the portion different from the above-described portion of obtaining the powder. The obtained cross-section observation sample was embedded in a resin, wet polishing was then performed with a #1200 emery paper, and the resultant was further subjected to diamond polishing (DP-suspension manufactured by Struers) to be mirror-finished, and then subjected to the observation.

With the SEM (JSM-7000F manufactured by JEOL Ltd.), the obtained cross section was observed by using reflected electrons in accordance with the method explained before. For the elemental analysis of the cross section, the SEM-EDS analysis was used.

### <Fe Mass % Analysis of Each Sealing Portion>

Production of analytical sample

Each of the main body part and the lid part of the accommodation case was produced in a manner similar to the manufacturing procedure of the lithium ion battery for the corrosion resistance evaluation described above, and then sealing was performed in a manner similar to the above. On the lithium ion battery obtained through such a manufacturing procedure, a first sealing portion similar to that of the lithium ion battery for the corrosion resistance evaluation is formed.

### Analysis

Each sealing portion was cut by the high-speed and high-precision cutting machine, to cut out a cross-section observation sample. The obtained cross-section observation sample was embedded in a resin, wet polishing was then performed with a #1200 emery paper, and the resultant was further subjected to diamond polishing (DP-suspension manufactured by Struers) to be mirror-finished, and then subjected to the observation.

With the SEM (JSM-7000F manufactured by JEOL Ltd.), the obtained cross section was observed by using reflected electrons in accordance with the method explained before. For the elemental analysis of the cross section, the SEM-EDS analysis was used.

The obtained results are collectively indicated in Table 1 below.

TABLE 1

| | | | [symbol] | | |
|---|---|---|---|---|---|
| | MATERIAL OF | | SEALING | | |
| | ACCOMMODATION | SEALING | PORTION | RUST PROOF TREATMENT AGENT | |
| No. | CASE | METHOD | MASS % | COMPOUND | LIQUID |
| 1 | NI-PLATED | WELDING | 90 | — | — |
| | STEEL SHEET | | | | |
| 2 | NI-PLATED | WELDING | 90 | Ca(OH)₂ | DEC |
| | STEEL SHEET | | | | |
| 3 | NI-PLATED | CAULKING | 100 | Ca(OH)₂ | DEC |
| | STEEL SHEET | | | | |
| 4 | NI-PLATED | WELDING | 90 | Ca(OH)₂ | DEC |
| | STEEL SHEET | | | | |
| 5 | NI-PLATED | WELDING | 90 | Ca(OH)₂ | DEC |
| | STEEL SHEET | | | | |
| 6 | NI-PLATED | WELDING | 90 | Ca(OH)₂ | DEC |
| | STEEL SHEET | | | | |
| 7 | NI-PLATED | WELDING | 90 | Ca(OH)₂ | DEC |
| | STEEL SHEET | | | | |
| 8 | NI-PLATED | WELDING | 90 | Ca(OH)₂ | DEC |
| | STEEL SHEET | | | | |
| 9 | NI-PLATED | WELDING | 90 | Ca(OH)₂ | DEC |
| | STEEL SHEET | | | | |
| 10 | NI-PLATED | WELDING | 90 | Ca(OH)₂ | DEC |
| | STEEL SHEET | | | | |
| 11 | NI-PLATED | WELDING | 90 | Ca(OH)₂ | DEC |
| | STEEL SHEET | | | | |
| 12 | NI-PLATED | WELDING | 90 | Ca(OH)₂ | DEC |
| | STEEL SHEET | | | | |
| 13 | NI-PLATED | WELDING | 90 | Ca(OH)₂ | DEC |
| | STEEL SHEET | | | | |
| 14 | NI-PLATED | WELDING | 90 | Ca(OH)₂ | DEC |
| | STEEL SHEET | | | | |
| 15 | NI-PLATED | WELDING | 90 | Ca(OH)₂ | EC |
| | STEEL SHEET | | | | |
| 16 | NI-PLATED | WELDING | 90 | Ca(OH)₂ | EC + DEC |
| | STEEL SHEET | | | | |
| 17 | NI-PLATED | WELDING | 90 | Ca(OH)₂ | DME |
| | STEEL SHEET | | | | |
| 18 | NI-PLATED | WELDING | 90 | — | ACRYLIC + |
| | STEEL SHEET | | | | BUTYL ACETATE |
| 19 | NI-PLATED | WELDING | 90 | — | ZINC PHOS- |
| | STEEL SHEET | | | | PHATE + DME |
| 20 | NI-PLATED | WELDING | 90 | — | PVDF + NMP |
| | STEEL SHEET | | | | |
| 21 | NI-PLATED | WELDING | 90 | Ca(OH)₂ | ACRYLIC + |
| | STEEL SHEET | | | | BUTYL ACETATE |
| 22 | NI-PLATED | WELDING | 90 | Ca(OH)₂ | PVDF + NMP |
| | STEEL SHEET | | | | |
| 23 | NI-PLATED | WELDING | 90 | Ca(OH)₂ | DEC |
| | STEEL SHEET | | | | |
| 24 | NI-PLATED | WELDING | 90 | CaO | DEC |
| | STEEL SHEET | | | | |
| 25 | LAMINATED | CAULKING | 100 | Ca(OH)₂ | DEC |
| | STEEL SHEET | | | | |
| 26 | LAMINATED | WELDING | 90 | Ca(OH)₂ | DEC |
| | STEEL SHEET | | | | |
| 27 | NI-PLATED | WELDING | 90 | [symbol] | DEC |
| | STEEL SHEET | | | | |
| 28 | NI-PLATED | WELDING | 90 | [symbol] | DEC |
| | STEEL SHEET | | | | |
| 29 | NI-PLATED | WELDING | 90 | Al₂O₃ | DEC |
| | STEEL SHEET | | | | |
| 30 | NI-PLATED | WELDING | 90 | [symbol] | DEC |
| | STEEL SHEET | | | | |
| 31 | NI-PLATED | WELDING | 90 | [symbol] | DEC |
| | STEEL SHEET | | | | |
| 32 | NI-PLATED | WELDING | 90 | [symbol] | DEC |
| | STEEL SHEET | | | | |
| 33 | NI-PLATED | WELDING | 90 | La(OH)₃ | DEC |
| | STEEL SHEET | | | | |
| 34 | NI-PLATED | WELDING | 90 | La(OH)₃ | DEC |
| | STEEL SHEET | | | | |
| 35 | NI-PLATED | WELDING | 90 | [symbol] | DEC |
| | STEEL SHEET | | | | |
| 36 | NI-PLATED | WELDING | 90 | [symbol] | DEC |
| | STEEL SHEET | | | | |
| 37 | NI-PLATED | WELDING | 90 | [symbol] | DEC |
| | STEEL SHEET | | | | |
| 38 | NI-PLATED | WELDING | 90 | [symbol] | DEC |
| | STEEL SHEET | | | | |
| 39 | SURFACE- | CAULKING | 100 | [symbol] | DEC |
| | TREATED | | | | |
| | STEEL SHEET | | | | |

| | COATING FILM PART | | | | OUTER | |
|---|---|---|---|---|---|---|
| | TOTAL | PROPOR- | ADHESION | UNEVEN | SURFACE | |
| | ADHESION | TION | AMOUN | DISTRI- | CORRO- | |
| | AMOUNT OF | OF | OF | BUTION | SION | |
| | Ca, Al, L [symbol] | Ca(OH)₂ | FLUORIDE | STATE OF | RESIS- | |
| No. | [g/m²] | [%] | [g/m²] | FLUORIDE | TANCE | REMARKS |
| 1 | 0.000 | 0 | 0.000 | — | D | COMPAR- |
| | | | | | | ATIVE |
| | | | | | | EXAMPLE |
| 2 | 300.000 | 100 | 0.000 | — | B | EXAMPLE |
| 3 | 300.000 | 99 | 0.100 | YES | A | EXAMPLE |
| 4 | 300.000 | 99 | 0.100 | YES | A | EXAMPLE |
| 5 | 300.000 | 99 | 0.050 | YES | A | EXAMPLE |
| 6 | 300.000 | 99 | 0.200 | YES | B | EXAMPLE |
| 7 | 0.100 | 80 | 0.010 | YES | A | EXAMPLE |
| 8 | 0.100 | 50 | 0.050 | YES | B | EXAMPLE |
| 9 | 50.000 | 99 | 0.100 | YES | A | EXAMPLE |
| 10 | 500.000 | 99 | 0.100 | YES | A | EXAMPLE |
| 11 | 200.000 | 99 | 0.100 | YES | B | EXAMPLE |
| 12 | 800.000 | 99 | 0.100 | YES | B | EXAMPLE |
| 13 | 1000.000 | 99 | 0.100 | YES | B | EXAMPLE |
| 14 | 1200.000 | 99 | 0.100 | YES | B | EXAMPLE |
| 15 | 300.000 | 99 | 0.100 | YES | A | EXAMPLE |
| 16 | 300.000 | 99 | 0.100 | YES | A | EXAMPLE |
| 17 | 300.000 | 99 | 0.100 | YES | A | EXAMPLE |
| 18 | 0.000 | 0 | 0.000 | — | D | COMPAR- |
| | | | | | | ATIVE |
| | | | | | | EXAMPLE |
| 19 | 0.000 | 0 | 0.000 | — | D | COMPAR- |
| | | | | | | ATIVE |
| | | | | | | EXAMPLE |
| 20 | 0.000 | 0 | 0.000 | — | D | COMPAR- |
| | | | | | | ATIVE |
| | | | | | | EXAMPLE |
| 21 | 300.000 | 99 | 0.100 | YES | A | EXAMPLE |
| 22 | 300.000 | 99 | 0.100 | YES | A | EXAMPLE |
| 23 | 300.000 | 0 | 0.100 | YES | B | EXAMPLE |
| 24 | 300.000 | 0 | 0.100 | YES | B | EXAMPLE |
| 25 | 300.000 | 99 | 0.100 | YES | A | EXAMPLE |
| 26 | 300.000 | 99 | 0.100 | YES | A | EXAMPLE |
| 27 | 300.000 | 0 | 0.100 | YES | C | EXAMPLE |
| 28 | 300.000 | 0 | 0.100 | YES | C | EXAMPLE |
| 29 | 300.000 | 0 | 0.100 | YES | C | EXAMPLE |
| 30 | 300.000 | 99 | 0.100 | YES | B | EXAMPLE |
| 31 | 300.000 | 99 | 0.100 | YES | B | EXAMPLE |
| 32 | 300.000 | 0 | 0.100 | YES | C | EXAMPLE |
| 33 | 300.000 | 0 | 0.100 | YES | B | EXAMPLE |
| 34 | 300.000 | 0 | 0.100 | YES | [symbol] | EXAMPLE |
| 35 | 300.000 | 0 | 0.100 | YES | [symbol] | EXAMPLE |
| 36 | 300.000 | 99 | 0.100 | YES | [symbol] | EXAMPLE |
| 37 | 300.000 | 99 | 0.100 | YES | [symbol] | EXAMPLE |
| 38 | 300.000 | 99 | 0.100 | YES | [symbol] | EXAMPLE |
| 39 | 300.000 | 99 | 0.100 | YES | A | EXAMPLE |

[symbol]

indicates data missing or illegible when filed

As is apparent from the above Table 1, each sample corresponding to the example of the present invention exhibited an excellent outer surface corrosion resistance, and on the other hand, each sample corresponding to the comparative example of the present invention could not obtain an excellent outer surface corrosion resistance.

The preferred embodiments of the present invention have been explained in detail above with reference to the attached drawings, but the present invention is not limited to such examples. It is apparent that a person having common knowledge in the technical field to which the present invention belongs is able to devise various variation or modification examples within the range of technical ideas described in the claims, and it should be understood that such examples belong to the technical scope of the present invention as a matter of course.

The embodiments disclosed herein are examples in all respects and should not be considered to be restrictive. The above-described embodiments may be omitted, substituted, or modified in various forms without departing from the scope of the appended claims and the configuration and gist that fall within the technical scope of the present invention as described below. For example, configuration requirements of the above-described embodiments can be arbitrarily combined within a range that does not impair the effects. Further, the operations and effects about the configuration requirements relating to an arbitrary combination can be obtained as a matter of course from the combination, and those skilled in the art can obtain clear other operations and other effects from the description herein.

Further, the effects explained herein are merely explanatory or illustrative in all respects and not restrictive. That is, the technique relating to the present invention can offer other clear effects to those skilled in the art from the description herein in addition to or in place of the above-described effects.

Note that the following configuration also belongs to the technical scope of the present invention.
(1) A lithium ion battery including an accommodation case having a main body part and a lid part, the accommodation case accommodating, in the inside thereof, a battery unit having a positive electrode, a negative electrode, and a separator, and an electrolytic solution containing a lithium salt, in which a Ni-plated steel sheet having a Ni-plating layer on a base steel sheet, or a laminated steel sheet having a surface-treated layer on a base steel sheet is used as a material of the accommodation case, on the accommodation case, at least any of a first sealing portion being a sealing portion between the main body part and the lid part, and a second sealing portion being a sealing portion between a liquid pouring port lid for sealing a liquid pouring port provided to the lid part and used for pouring the electrolytic solution into the accommodation case, and the lid part exists, and a coating film part containing at least any of a Ca compound, an Al compound, and a La compound exists on a portion with a content of Fe of 80 mass % or more, of the first sealing portion or the second sealing portion.
(2) In the lithium ion battery described in (1), a total adhesion amount of the Ca compound in terms of metal Ca, the Al compound in terms of metal Al, and the La compound in terms of metal La, in the coating film part is 0.001 g/m² or more and 1000.000 g/m² or less.
(3) In the lithium ion battery described in (1) or (2), the Ca compound, the Al compound, and the La compound are dispersed in a resin in the coating film part.
(4) In the lithium ion battery described in any one of (1) to (3), the Ca compound is at least any of a calcium carbonate, a calcium oxide, and a calcium hydroxide, the Al compound is at least any of an aluminum carbonate, an aluminum oxide, and an aluminum hydroxide, and the La compound is a lanthanum carbonate, a lanthanum oxide, or a lanthanum hydroxide.
(5) In the lithium ion battery described in any one of (1) to (4), 80 mass % or more of the Ca compound in terms of metal Ca is the calcium hydroxide.
(6) In the lithium ion battery described in any one of (1) to (5), the coating film part further contains a fluoride as the Ca compound, the Al compound, or the La compound.
(7) In the lithium ion battery described in (6), the fluoride exists more on a side of interface with the base steel sheet constituting the Ni-plated steel sheet or the laminated steel sheet than on a side of surface of the coating film part.
(8) In the lithium ion battery described in (6) or (7), an adhesion amount of the fluoride in terms of fluorine is greater than 0 g/m² and 0.200 g/m² or less.
(9) In the lithium ion battery described in any one of (1) to (8), the first sealing portion and the second sealing portion are formed through welding or caulking.
(10) A manufacturing method of a lithium ion battery that includes an accommodation case having a main body part and a lid part, the accommodation case accommodating, in the inside thereof, a battery unit having a positive electrode, a negative electrode, and a separator, and an electrolytic solution containing a lithium salt, in which on the lithium ion battery, at least any of a first sealing portion being a sealing portion between the main body part and the lid part, and a second sealing portion being a sealing portion between a liquid pouring port lid for sealing a liquid pouring port provided to the lid part and used for pouring the electrolytic solution into the accommodation case, and the lid part is formed, and a Ni-plated steel sheet having a Ni-plating layer on a base steel sheet, or a laminated steel sheet having a surface-treated layer on a base steel sheet is used as a material of the accommodation case, the manufacturing method of the lithium ion battery including: a sealing step of sealing between the main body part and the lid part, and between the liquid pouring port lid and the lid part to form the first sealing portion and the second sealing portion, regarding the accommodation case that accommodates the battery unit and the electrolytic solution; and a coating step of coating a top of a portion with a content of Fe of 80 mass % or more, of the first sealing portion or the second sealing portion, with paint containing at least any of a Ca compound, an Al compound, and a La compound, after performing the sealing between the main body part and the lid part, and between the liquid pouring port lid and the lid part.
(11) In the manufacturing method of the lithium ion battery described in (10), the sealing step is performed under an atmosphere of a dew point of −75° C. or less.

### EXPLANATION OF CODES

1 lithium ion battery
3 battery unit
5 electrolytic solution
10 accommodation case
11 main body part
13, 13A lid part
liquid pouring port
17 liquid pouring port lid
21 first sealing portion
23 second sealing portion
30 coating film part
100 Ni-plated steel sheet
100A laminated steel sheet
100B surface-treated steel sheet
101 base steel sheet
103 Ni-plating layer
105 surface-treated layer
201 portion to be coated
203 sealing

1. A lithium ion battery comprising an accommodation case having a main body part and a lid part, the accommodation case accommodating, in the inside thereof, a battery unit having a positive electrode, a negative electrode, and a separator, and an electrolytic solution containing a lithium salt, wherein:
a Ni-plated steel sheet having a Ni-plating layer on a base steel sheet, or a laminated steel sheet having a surface-treated layer on a base steel sheet is used as a material of the accommodation case;
on the accommodation case, at least any of a first sealing portion being a sealing portion between the main body part and the lid part, and a second sealing portion being a sealing portion between a liquid pouring port lid for sealing a liquid pouring port provided to the lid part and used for pouring the electrolytic solution into the accommodation case, and the lid part exists; and
a coating film part containing at least any of a Ca compound, an Al compound, and a La compound exists on a portion with a content of Fe of 80 mass % or more, of the first sealing portion or the second sealing portion.

2. The lithium ion battery according to claim 1, wherein
a total adhesion amount of the Ca compound in terms of metal Ca, the Al compound in terms of metal Al, and the La compound in terms of metal La, in the coating film part is 0.001 g/m² or more and 1000.000 g/m² or less.

3. The lithium ion battery according to claim 1, wherein
the Ca compound, the Al compound, and the La compound are dispersed in a resin in the coating film part.

4. The lithium ion battery according to claim 2, wherein
the Ca compound, the Al compound, and the La compound are dispersed in a resin in the coating film part.

5. The lithium ion battery according to claim 1, wherein:
the Ca compound is at least any of a calcium carbonate, a calcium oxide, and a calcium hydroxide;
the Al compound is at least any of an aluminum carbonate, an aluminum oxide, and an aluminum hydroxide; and
the La compound is a lanthanum carbonate, a lanthanum oxide, or a lanthanum hydroxide.

6. The lithium ion battery according to claim 5, wherein
80 mass % or more of the Ca compound in terms of metal Ca is the calcium hydroxide.

7. The lithium ion battery according to claim 5, wherein
the coating film part further contains a fluoride as the Ca compound, the Al compound, or the La compound.

8. The lithium ion battery according to claim 6, wherein
the coating film part further contains a fluoride as the Ca compound, the Al compound, or the La compound.

9. The lithium ion battery according to claim 7, wherein
the fluoride exists more on a side of interface with the base steel sheet constituting the Ni-plated steel sheet or the laminated steel sheet than on a side of surface of the coating film part.

10. The lithium ion battery according to claim 8, wherein
the fluoride exists more on a side of interface with the base steel sheet constituting the Ni-plated steel sheet or the laminated steel sheet than on a side of surface of the coating film part.

11. The lithium ion battery according to claim 7, wherein
an adhesion amount of the fluoride in terms of fluorine is greater than 0 g/m² and 0.200 g/m² or less.

12. The lithium ion battery according to claim 8, wherein
an adhesion amount of the fluoride in terms of fluorine is greater than 0 g/m² and 0.200 g/m² or less.

13. The lithium ion battery according to claim 9, wherein
an adhesion amount of the fluoride in terms of fluorine is greater than 0 g/m² and 0.200 g/m² or less.

14. The lithium ion battery according to claim 10, wherein
an adhesion amount of the fluoride in terms of fluorine is greater than 0 g/m² and 0.200 g/m² or less.

15. The lithium ion battery according to claim 1, wherein
the first sealing portion and the second sealing portion are formed through welding or caulking.

16. A manufacturing method of a lithium ion battery that includes an accommodation case having a main body part and a lid part, the accommodation case accommodating, in the inside thereof, a battery unit having a positive electrode, a negative electrode, and a separator, and an electrolytic solution containing a lithium salt, wherein:
on the lithium ion battery, at least any of a first sealing portion being a sealing portion between the main body part and the lid part, and a second sealing portion being a sealing portion between a liquid pouring port lid for sealing a liquid pouring port provided to the lid part and used for pouring the electrolytic solution into the accommodation case, and the lid part is formed; and
a Ni-plated steel sheet having a Ni-plating layer on a base steel sheet, or a laminated steel sheet having a surface-treated layer on a base steel sheet is used as a material of the accommodation case, the manufacturing method of the lithium ion battery comprising:
a sealing step of sealing between the main body part and the lid part, and between the liquid pouring port lid and the lid part to form the first sealing portion and the second sealing portion, regarding the accommodation case that accommodates the battery unit and the electrolytic solution; and
a coating step of coating a top of a portion with a content of Fe of 80 mass % or more, of the first sealing portion or the second sealing portion, with paint containing at least any of a Ca compound, an Al compound, and a La compound, after performing the sealing between the main body part and the lid part, and between the liquid pouring port lid and the lid part.

17. The manufacturing method of the lithium ion battery according to claim 16, wherein
the sealing step is performed under an atmosphere of a dew point of −75° C. or less.
